(19) United States
(12) Patent Application Publication
(10) Pub. No.: US 2003/0172142 A1
(43) Pub. Date: Sep. 11, 2003

(54) Method for building a vapa by using wireless-LAN interface card

(76) Inventor: David Su, Hsinchu City (TW)

Correspondence Address: SUPREME PATENT SERVICES, POST OFFICE BOX 2339, SARATOGA, CA, 95070, US

(21) Appl. No.: 10/094,863

(22) Filed: Mar. 11, 2002

(51) Int. Cl. G06F 15/16

(52) U.S. Cl. 709/223; 709/250

(57) ABSTRACT

A method applicable under the circumstance of the Windows server is provided for building a virtual access point architecture (VAPA) by using a wireless-LAN interface card, which is installed to an Ethernet, such that a wireless network is coexisted with an Ethernet for sharing the Internet resources through the network address translator (NAT) and for mutual access of those two LANs through a WINS (Windows Internet Naming Service) server, in which some other wireless subscribers are connected through the Ad-Hoc framework.

### FIELD OF THE INVENTION

This invention relates to a wireless-LAN communication system, particularly to a communication system, in which a wireless-LAN interface card is adopted in substitution for a wireless-LAN access point.

### BACKGROUND OF THE INVENTION

A local area network (LAN) is a relatively narrow network consisting of at least two linked computers, which might be extended to grow into a wide area network (WAN).

The worldwide Internet is an aggregation of numerous LANs controlled by TCP/IP regulations according to IEEE802.3 standards via an Ethernet—a local area network (LAN) in form of bus-architecture—and is operated in a connectionless state for transmitting and distributing information to a plurality of host modules through respective cables.

FIG. 1 illustrates a block diagram of the connection framework of an already known network. In FIG. 1, a wireless-LAN and an Ethernet are connected to the Internet, in which the individual desktop computers or portable computers in the wireless field are coupled with the network without direct connections.

### SUMMARY OF THE INVENTION

The primary object of this invention is to provide a method for building a virtual access point architecture (VAPA) by using a wireless-LAN interface card in substitution for a wireless network access point (AP) to have a wireless network coexisted with an Ethernet for sharing the Internet through the network address translator (NAT) and for mutual access of those two LANs through a WINS (Windows Internet Naming Service) server.

In order to realize abovesaid object, the method applicable under the circumstance of the Windows server is provided for building a VAPA by using a wireless-LAN interface card to thereby construct a wireless communication area for sharing the Internet resources comprising the following steps:

(1) To install a wireless-LAN interface card on an Ethernet server and establish a wireless-LAN in form of Ad-Hoc for wireless subscribers;

(2) To install a DHCP (Dynamic Host Configuration Protocol) server and set the subscriber's IP (Internet Protocol) address obtainable automatically;

(3) To install a NAT (Network Address Translation) server for translating a subscriber's private IP address into a public IP address to thereby connect with the Internet; and

(4) To install a WINS server to convert NetBIOS into IP and enable both the subscribers of those two LANs to access the counterpart's LAN directly by the name of NetBIOS.

The procedure for installing the DHCP server further comprises a step for splitting the private network protocol into subnet masks on DHCP basis such that an Ethernet and a wireless-LAN are provided with 125 IP addresses respectively while a private dynamic IP address is assigned to each subscriber.

Again, the procedure for installing the DHCP server further comprises a step for installation of a WINDOWS server on a computer having the NIC (Network Interface Card) in three pieces, in which the IP address of a first and a second Ethernet interface card are legal and virtual respectively, and that of a third wireless-LAN interface card is also virtual. Then, the procedure is to connect an ADSL modem to the first NIC and the second NIC to the hub while the third will serve for a wireless-LAN gateway. Now, a next step is to set up DHCP service to the WINDOWS server and assign the subnet mask of IP to the DHCP server for management, in which all the IP of subscribers are obtainable automatically such that the DNS (Domain Name Service) could be set to a DNS server provided by an ISP (Internet Service Provider) and the gateway could be set to an Ethernet or a wireless-LAN.

The procedure for installing a WINS server includes a step for setting the information of the WINS server of an assigned subscriber in the DHCP server.

This invention further comprises a procedure for setting-up a NAT server, that is, to execute “routing and remote accessing” and “setting a router conforming to NAT communication protocol” of the WINDOWS 2000 server so as to set a router on the first NIC to enable the subscribers of both the Ethernet and the wireless-LAN to access the Internet through the same NAT server.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 shows the configuration of the conventional network connection;

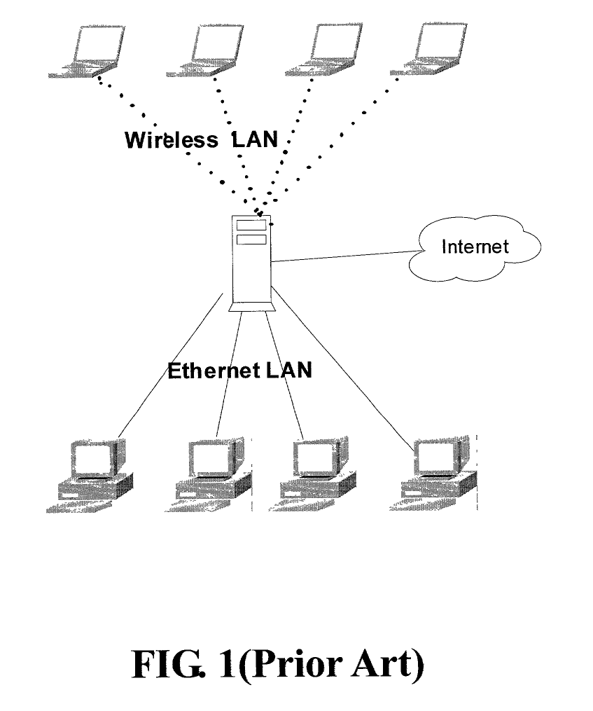

FIG. 2 shows a transfer flowchart of NAT;

FIG. 3 shows that a NAT server is providing service to a plurality of PCs;

FIG. 4 shows the IP broadcast process between workstations;

FIG. 5 shows the framework of a preferred embodiment of this invention;

FIG. 6 shows a flowchart of the preferred embodiment of this invention; and

FIG. 7 shows the configuration of the preferred embodiment including the NAT server, the WINS server, etc.

### DETAILED DESCRIPTION OF THE INVENTION

A method of this invention for building a VAPA (Virtual Access Point Architecture) by using a wireless-LAN (Local Area Network) interface card is to set up a wireless-LAN interface card on an Ethernet server and build a wireless-LAN in form of Ad-Hoc for wireless subscribers. The method is firstly to set up a DHCP (Dynamic Host Configuration Protocol) server for splitting individual private IP (Internet protocol) address such that a plurality of IP addresses is provided to the respective Ethernet and wireless-LAN, and a dynamic IP address is assigned to every subscriber end, in which the dynamic IP address is set obtainable automatically.

The DHCP server is in charge of managing and distributing the IP address. A computer will become a DHCP subscriber after an IP address is rented from that DHCP server, and this IP address could be reassigned to some other computer upon expiry of the rental agreement.

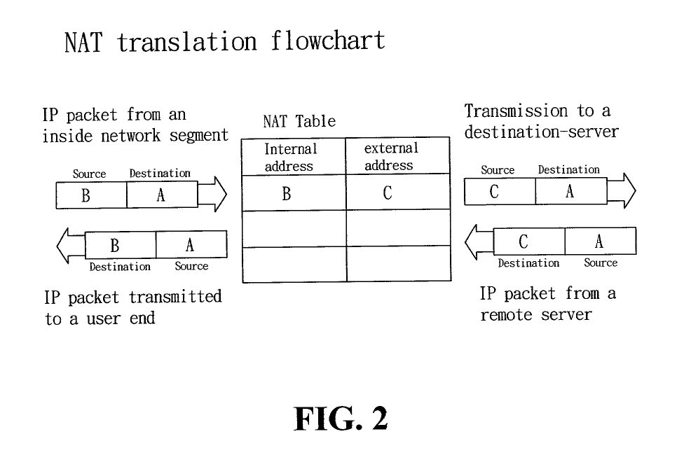

As shown in FIG. 2, a network address translator (NAT) is a NAT router to serve as an intermedium between an internet and an external network for rewriting the TCP/UDP header of a packet received from an internet and changing a virtual IP into a legal IP for transmission. Similarly, the NAT also translates a packet received an external network and transmits it to an internal workstation or server.

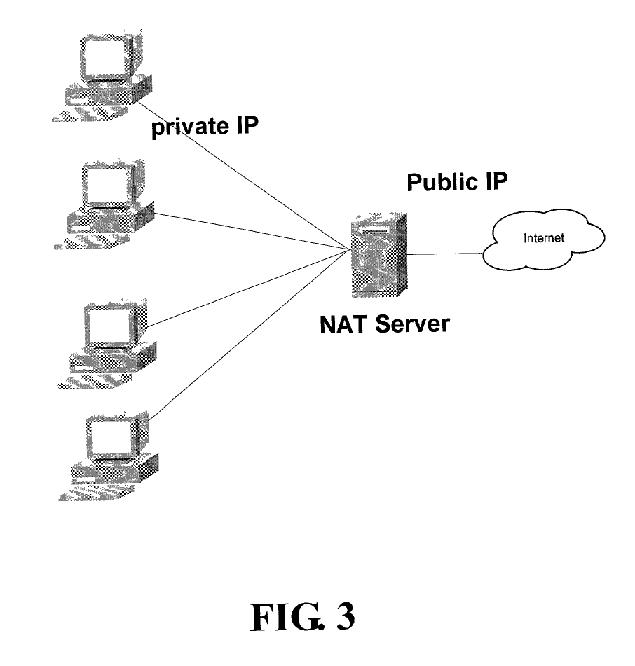

The operation manner of the NAT is classified in three categories, namely an one-to-one, multiple-to-one, and multiple-to-multiple style, in which the one-to-one style corresponding to an external server is to convert a virtual IP into a legal IP; the multiple-to-one shown in FIG. 3 is arranged to solve the problem of legal IP scarcity, in which all the virtual IPs provided in an entire internet is expressed in form of legal IPs of the NAT router such that all the network services requested nominally by the NAT router is in reality made by the internet. Similarly, the multiple-to-multiple is arranged for dealing with a large number of workstations also for solving the problem of legal IP insufficiency.

Now, the procedure is to set up a WINS (Windows Internet Naming Service) server for the subscribers of both the wireless-LAN and the Either-LAN to access the counterpart's network by the name of NetBIOS and by changing the IP through the WINS server, which supports the WINDOWS computers of the subscribers and the servers for name-resolution and for IP address discrimination of a computer in a network. In the case the IP addresses are distributed dynamically by the DHCP server, to be advised of the IP address of a specified computer is a rather complicated task. Fortunately, the WINS can update the name of computers and the distributed database of the IP address for name-resolution.

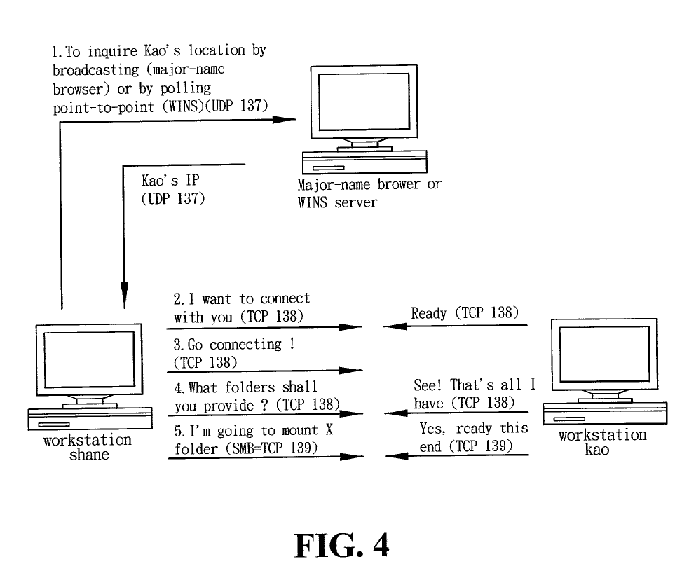

FIG. 4 shows the IP broadcast process between workstations. In FIG. 4, the WINS server is capable of solving the problems occurred during resolution of the name of NetBIOS by means of IP broadcast and having the file manager ignored updating the static corresponding files, because the WINS database can be updated automatically when a computer moving between subnets is provided with a new IP address under DHCP static addressing mode. Therefore, a user and the file manager will need not to adapt themselves to the name-resolution.

When polling a major-name browser for a NAT frame by way of broadcasting, it usually cannot break through a router or firewall unless a point-to-point transmission manner is adopted, in which a destination IP has to be assigned. The major-name browser, where the IP belongs to, is named a WINS server, whereby the polling system by way of regular broadcast between workstations is deflected to poll with in order to relieve the burden of the networks.

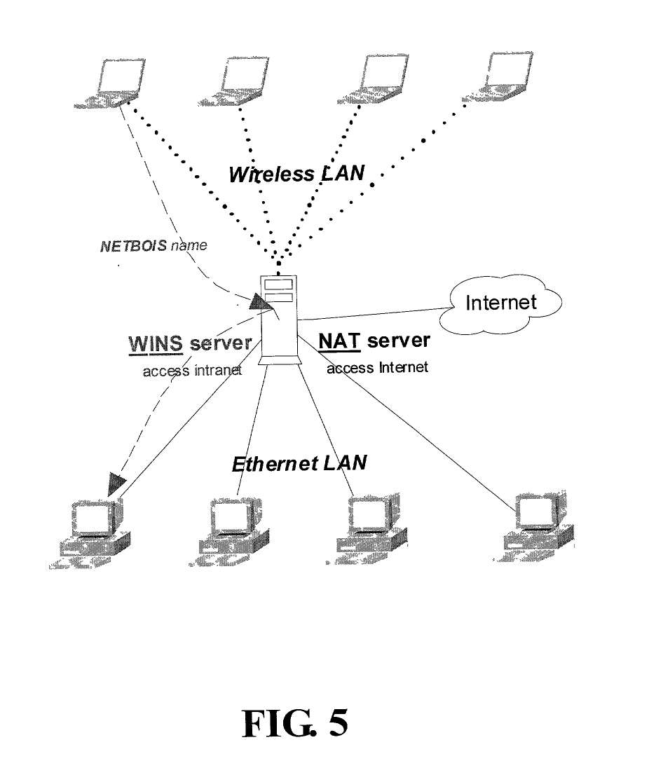

FIG. 5 shows the framework of a preferred embodiment of this invention. This invention is to provide a method for building a wireless-LAN with other subscribers to coexist with an Ethernet by adding a wireless-LAN interface card, such that it is possible for the subscribers to share the Internet through the NAT server and access both the wireless-LAN and the Ethernet mutually for inside resources through the WINS server.

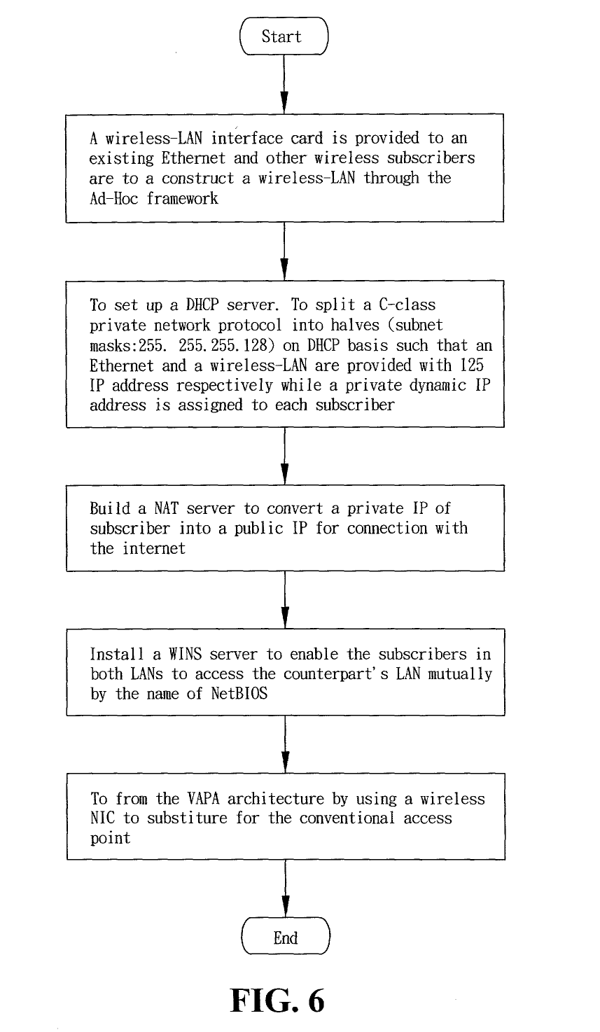

FIG. 6 shows the flowchart of the preferred embodiment of this invention. As indicated in FIG. 6, the wireless-LAN interface card is provided to an existing Ethernet and some other subscribers are to build a wireless-LAN through the Ad-Hoc framework. For building such a wireless-LAN with Ethernet coexisted, the procedure is to firstly set up a DHCP server and split private networks in accordance with regulations of DHCP to thereby provide a plurality of IP addresses to the Ethernet and the wireless-LAN and an automatically obtainable dynamic IP address to every subscriber; then, build a NAT server to thereby convert a private IP of subscriber into a public IP for connection with the Internet; and set up a WINS server for conversion of IP to enable the subscribers of both LANs to mutually access the counterpart's LAN directly by the name of NetBIOS.

To set up the DHCP server, a step is firstly to install a WINDOWS server in a computer having NIC (Network Interface Card) in three pieces, in which the first piece is an Ethernet card having a legal IP, such as 202.145.73.188; the second piece is also an Ethernet card having a virtual IP address, such as 192.168.0.1; and the third piece is a wireless-LAN card having a virtual IP address, such as 192.168.0.129.

A following step is to connect an ADSL (Asymmetric Digital Subscriber Line) modem to the first piece NIC and the second piece NIC to the hub, while the third piece NIC is supposed to serve directly for a wireless-LAN gateway.

A next step is to set up DHCP service to the WINDOWS server, that is, to assign a group of Ethernet having IP 192.168.0.1˜126 (subnet mask: 255.255.255.128) and a group of wireless-LAN having IP 192.168.0.129˜254 (subnet mask: 255.255.255.128) under the management of DHCP.

Because the IP address of every subscriber computer is set obtainable automatically, therefore the DNS (Domain Name Service) could be set on the DNS server provided by an ISP (Internet Service Provider), for example, to set the address of the DNS server of TTN at 210.17.1.1 and set an Ethernet and a wireless-LAN as 192.168.0.1 and 192.168.0.129 respectively for presetting the gateways.

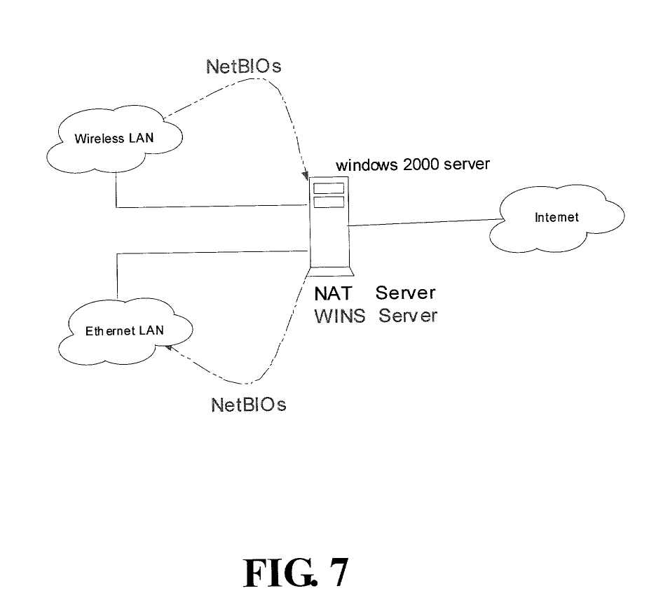

A next step is to install the NAT and the WINS of DHCP as shown in FIG. 7. For installation of the NAT, the procedure is to execute the “routing and remote access” on the WINDOWS; select an IP route; select the NAT as the added routing communication protocol; execute “setting a router under NAT routing communication protocol” and set the router on the first network interface card so that all the subscribers of the wireless-LAN and the Ethernet is enabled to access the Internet for resources through the same NAT. The final step is to install the WINS by setting up a WINS server firstly, then providing information of a specified subscriber WINS server in the DHPC server.

In short, this invention is to add a wireless interface card on an Ethernet server to thereby enable all the subscribers of a wireless-LAN and the Ethernet to go accessing the Internet and mutually access respective LANs to share information through the WINS server.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A method for building a virtual access point architecture (VAPA) by using a wireless-LAN (Local Area Network) interface card under the circumstance of WINDOWS server to thereby establish a wireless-LAN for communications, the method comprising the following procedures:
(1) To install a wireless-LAN interface card on an Ethernet server and establish a wireless-LAN in form of Ad-Hoc for the wireless subscribers;
(2) To install a DHCP (Dynamic Host Configuration Protocol) server and et the subscriber's IP (Internet Protocol) address obtainable automatically;
(3) To install a NAT (Network Address Translation) server for translating a subscriber's private IP address into a public IP address to thereby connect with the Internet; and
(4) To install a WINS (Windows Internet Naming Service) server to convert NetBIOS into IP and enable both the subscribers of those two LANs to access the counterpart's LAN directly by the name of NetBIOS.

2. The method according to claim 1, in which the procedure for installing the DHCP server further comprises a step for splitting the private network protocol into subnet masks on DHCP basis such that an Ethernet and a wireless-LAN are provided with a plurality of IP addresses respectively while a private dynamic IP address is assigned to each subscriber.

3. The method according to claim 2, in which the dynamic IP address is private.

4. The method according to claim 1, in which the procedure for installing the DHCP server further comprises a step for installing a WINDOWS server on a computer having the NIC (Network Interface Card) in three pieces, in which the IP address of a first and a second Ethernet interface card are legal and virtual respectively, and that of a third wireless-LAN interface card is also virtual.

5. The method according to claim 4, further comprising a procedure for connecting an ADSL modem to the first NIC and the second NIC to the hub while the third will serve for a wireless-LAN gateway.

6. The method according to claim 5, further comprising a procedure for setting up DHCP service to the WINDOWS server and assign the subnet mask of IP to the DHCP server for management.

7. The method according to claim 6, in which as the IP address of all the subscribers is set obtainable automatically and the gateway of the Ethernet and the wireless-LAN are preset, hence the domain name service (DNS) is set to the DNS server provided by an ISP.

8. The method according to claim 1, in which the procedure for installing a WINS server includes a step for setting the information of the WINS server of an assigned subscriber in the DHCP server.

9. A system for building a virtual access point architecture (VAPA) by using a wireless-LAN interface card, the system comprising a plurality of networks, in which each network has a plurality of server computers always connected with the network; and a method for the subscribers of the server computers to connect the network comprises the following procedures:
(1) To install a wireless-LAN interface card on an Ethernet server and establish a wireless-LAN in form of Ad-Hoc for the wireless subscribers;
(2) To install a DHCP (Dynamic Host Configuration Protocol) server and set the subscriber's IP (Internet Protocol) address obtainable automatically;
(3) To install a NAT (Network Address Translation) server for translating a subscriber's private IP address into a public IP address to thereby connect with the Internet; and
(4) To install a WINS server to convert NetBIOS into IP and enable both the subscribers of those two LANs to access the counterpart's LAN directly by the name of NetBIOS.
